(19) United States
(12) Patent Application Publication
(10) Pub. No.: US 2015/0258571 A1
(43) Pub. Date: Sep. 17, 2015

(54) Paint Composition and Method

(71) Applicant: Yesnil Pty Ltd., Maroochydore (AU)

(72) Inventors: Warwick Lindsay, Minyama (AU); William Evans, Maroochydore (AU); Nadarajah Ketheeswaran, Kunda Park (AU)

(21) Appl. No.: 14/213,572

(22) Filed: Mar. 14, 2014

(51) Int. Cl. B05D 1/26; B65D 35/38; C09D 175/04; C08K 5/205; C08K 3/36; C08K 5/053; B65D 35/08; B65D 35/44

(52) U.S. Cl. CPC B05D 1/26; B65D 35/08; B65D 35/38; B65D 35/44; C08K 5/205; C08K 3/36; C08K 5/053; C09D 175/04

(57) ABSTRACT

There is provided a paint composition including, by weight 62 to 89 weight % water based urethane copolymer latex having a polymer solids content of from 30% to 70% by weight, 1 to 3 weight % of a lower-alkylene glycol, 8 to 23 weight % microsphere filler, 1 to 9 weight % colorant, and 1 to 3 weight % of a shear viscosity reducing rheological modifier, providing improved finishing of repairs.

### FIELD OF THE INVENTION

This invention relates to a paint composition. This invention has particular application to a high-fill touch-up paint composition for repair of coated fibreglass surfaces, and for illustrative purposes the invention will be described with reference to this application. However we envisage that this invention may find use in other applications such as automotive lacquer, painted-surface, ceramics or enamel repairs.

### BACKGROUND OF THE INVENTION

The reference to any prior art in this specification is not, and should not be taken as, an acknowledgement or any form of suggestion that the referenced prior art forms part of the common general knowledge in Australia.

The aesthetics of many items can be spoiled by an imperfection in their surface coating. This is true of a wide variety of items such as painted walls in houses, building architraves or skirtings, white goods, other electrical items, floor/wall tiles or ceramic or porcelain glazed pots and other items, other flooring, fibreglass swimming pools and Jacuzzi gel coats, fibreglass boat gel coat, polyethylene canoes, boats, surfboards or other water craft and cars plus other vehicles.

Consumers often take a certain amount of pride in the appearance of these products and want the damaged area repaired to as close to its original appearance as possible. Houses, buildings, swimming pools and Jacuzzis, surfboards, canoes, other boats, flooring, cars, motorbikes, recreational vehicles, trucks and the like are premium purchases whose aesthetics are particularly important to the owner.

Chips, dents, cracks and scratches in the exterior finishes are, unfortunately, an inevitable consequence of these items. Whilst matching colour is important correctly levelling the repairs height to match the adjacent areas height is optically crucial.

There are a large number of touch-up repair products available which operate in essentially the same manner. The most invisible repairs are those confined to only the size of the damage or a full or part panel/area respray. Respraying requires skill and raises workplace safety issues. These repairs are particularly more problematic when a chip, scratch or crack appears on a vertical panel of a house, building, boat, flooring, car, motorbike, recreational vehicle, or a truck.

Gravity may cause touch up products to slump or run onto the adjacent undamaged areas increasing the repair surface area which further highlights the repair. The user must take great care to only apply a minimal amount of the filler and paint or gel coat into the damage to minimise repair product runs. This laborious process requires accurate hand eye co-ordination. Therefore DIY repairers have difficulty achieving almost invisible repairs.

The prior arts methods include those which require that the cosmetically-damaged area's cracked, chipped or scratched surfaces are cleaned prior to application of a settable filler which may be applied with a trowel or spatula. Once set, excess surface filler may be then sanded until level. This type of repair then requires touch-up paint to be sprayed or brushed over the repair and adjacent areas. The paints used are typically lacquers and the like with high volatile organic solvent contents. Spraying requires a very accurate colour match because the repair area is then considerably larger than the original damage. However when damage less than 3 mm wide, the repair will usually blend with much less need for perfect colour matching accuracy.

Alternatively the repairer may trowel a drying filler into the damage. As the filler dries it will generally shrink. The repairer may carefully brush matching paint inside the damage. However the degree of shrinkage is difficult to assess. The process takes considerable time. Multiple touch-up applications may be necessary to achieve sufficient colour coverage and fill to the height of the adjacent undamaged surface.

Some prior art processes require building up layers of the touch up paint until the touch up paint is higher than the surrounding body paint. The surface tension characteristics of many commercial touch up paints means the paint dries with high edges and a lower centre. Once the paint is dry it must then be smoothed down to the adjoining areas height using wet or dry papers, cutting compounds and/or other abrasive products, generally followed by a fine polish.

Fibreglass panels of cars, spoilers, swimming pools/Jacuzzis, recreational vehicles, truck bodies, shower stalls, and boats having damage like chips, cracks, scratches and the like generally require the area to be cleaned first. Larger damage is repaired with resin with its catalyst and fibreglass matting or other reinforcement. The repair is then levelled with an electric or hand sander or the like and a surface gel coat mixed with the appropriate colour is applied. Once dry this repair is then sanded/polished to blend with the adjoining area.

The abrasive finishing of prior art repairs requires considerable skill to prevent rub through to undercoats and base coats, and to avoid leaving rub or burnish marks on the repair and the surrounding surface coating. Repairs must be checked for scratching and burnish marks from many different light angles at differing times of the day and evening or also under fluorescent or other artificial lighting found in car parks or garages. Due to the complexity of the checking it means this type of damage can be missed by even the most experienced tradesman.

In addition, when repairing with paints like acrylic lacquers, these continue to shrink for years results in the repair/s which are level at application being uneven after as little as a month, and will continue to shrink over future years. Two-pack paints have a higher film build and high solids content resulting in reduced shrinkage, but are unsuited to “infield” use due to health concerns for the operator. Their slow surface curing characteristics require a ‘dust free’ environment like a painting booth.

Additionally it is important for the touch up paints to be mixed properly before use otherwise an incorrect colour of paint is laid down.

DIY repair of chips and scratches, particularly on vehicles, ceramic tiles, garden pots and other ceramic items, boats and other fibreglass, painted walls and doors is a popular and cost effective way for owners to maintain their goods. It would be desirable to provide for a touch up repair system which is easier to use than conventional paints and which gives a pleasing to the eye repair finish.

### SUMMARY OF THE INVENTION

In one aspect the present invention resides broadly in a paint composition including, by weight:
62 to 89 weight % water based urethane copolymer latex having a polymer solids content of from 30% to 70% by weight;
1 to 3 weight % of a lower-alkylene glycol;
8 to 23 weight % microsphere filler;
1 to 9 weight % colorant; and
1 to 3 weight % of a shear viscosity reducing rheological modifier.

### DETAILED DESCRIPTION OF THE INVENTION

Throughout this specification, unless the context requires otherwise, the words “comprise”, “comprises” and “comprising” will be understood to imply the inclusion of a stated integer or group of integers but not the exclusion of any other integer or group of integers.

The water based urethane copolymer latex may comprise any known polyurethane binder composition of the type known to the coatings art. For example, the water based urethane latex composition may be selected from cross-linked, aliphatic waterborne urethane polymer compositions such as those selected for good water and solvent resistance. Such products produce tough, clear, high gloss films with outstanding chemical resistance. The cross-linked urethane copolymer may comprise urethane prepolymer (e.g. such as that produced by the reaction of a diisocyanate with a polyether polyol) having unreacted NCO sites bound by reaction with hydroxyl group functionality on modified vinyl or (meth)acrylic acid addition-polymerizable monomers, the resulting modified urethane prepolymer being emulsion-phase polymerized in the present of free radial catalysts. Alternatively the copolymer may be a block copolymer, crosslinked by any means known in the art. Typically the copolymer is an acrylic modified polyurethane.

The latex quantity and solid content may be selected having regard to the filler, mica and colorant content. At higher filler loadings, the wet out characteristics of the filler components in taking up the aqueous phase of the latex may allow the use of a lower binder solids loading while obtaining a continuous binder phase in the dried touch-up product.

The lower polyalkylene glycol may be selected from polyethylene glycol and a polypropylene glycol (1,2 or 1,3 propanediol). The selected glycol may be any generally valuable as a brushing agent and for temperature stability and as a coalescing aid in paints.

The microsphere filler may be selected from silica (“glass”), mineral, polymer and other upper-nanometre-scale to micron-scale particulate fillers. It is desirable that the filler not unduly mask the pigment and mica (metallic) effects of the touch up paint. For this reason, it is preferred to use unpigmented microsphere fillers that are transparent, that is, whose relatively white opacity is a result of light scattering in a microsphere of otherwise transparent material. For example, the filler may comprise solid silica “glass” microspheres or hollow glass microballoons having diameters ranging from about 5 to 300 micrometers, and preferably from more than 5 micro metres to less than 120 micro metres.

The colorant employed in the composition may be selected on the basis of colour matching. Colour matching a necessarily empirical process having regard to both the original “colour card” of the surface to be repaired, and a factor for ordinary weathering of the surface to be repaired. It has been surprisingly determined that compositions of the present invention produce a substantially invisible repair with a wide tolerance for variation in hue between the repair surface and touch up composition, for reasons described hereinafter.

Pigment loadings in latex paint formulations are well tabulated from long practical compounding history and rely on particle shape, size and size distribution, milling methods and cofactors and dispersants and the like. The present compositions may include any of the colorants compatible with the chemical system in use and include solid colour pigments such as carbon black, titanium dioxide, other metal oxides, magnesium aluminium silicates, mica particles of varying sizes, and synthetic mineral or organic pigments.

The relative percentage amount of which the colorant is present in the composition of the first aspect will vary greatly depending on the particular colour chosen. This is an issue which is common to the paint trade and would be well understood by the skilled addressee who would be aware of which colorants would be required to be present in greater or lesser relative amounts.

The rheology modifier may comprise a compound or composition selected to enable mechanical smoothing of the composition, by a method such as that described hereinafter. For example the rheology modifier may be selected to induce shear thinning and/or thixotropy in the composition. Shear thinning liquids are liquids whose viscosity decreases with the rate of shear stress. Thixotropic liquids become less viscous over time when shaken, agitated, or otherwise stressed.

Typically, the rheological modifiers are selected from the group consisting of urethane or hydrophobically modified urethane or alkali soluble rheological modifiers. Non-ionic urethane rheology modifiers used to formulate exterior and interior paint coatings with high resistance to water, alkali and microbial attack, a wide pH range, and providing high low-shear viscosity with high shear thinning rheology and good thickening efficiency is preferred.

Typically the composition will include less than 2% by weight of the rheology modifier and more typically between about 0.5% and 1.5% by weight. The rheology modifier may require pre-dispersal in a small quantity of water.

The microsphere filler load of the composition may be replaced in part by the mica. Where metallic or pearlescent effects are required, the filler load ascribed to microsphere filler may be replaced in part by the mica.

It will be appreciated that while the composition of the first aspect is substantially as described above, other additives may be present in relatively small amounts to modify the characteristics of the composition. They include surface active additives, co-solvents and additives to promote drying, film forming and/or adhesion.

Paint compositions in accordance with the present invention may be formulated by any means known to the art. For example the water content of the base latex composition may be supplied in part by sufficient extra water into which has been dispersed the rheology modifier. A low shear mixer may be preferred to blend the lower-alkylene glycol, microsphere filler, mica, colorant, and the pre-dispersed rheological modifier, to avoid high-shear reduction of the microspheres.

In a further aspect the invention resides broadly in a paint composition comprising, by weight;
67 to 70% water based urethane copolymer latex having a polymer solids content of from 30% to 70%;
1 to 3% of a lower-alkylene glycol;
18 to 23% microsphere filler;
1 to 9% colorant; and
1 to 3% of a shear viscosity reducing rheological modifier.

In a further aspect the invention resides broadly in a paint composition comprising, by weight:
67 to 70% water based urethane copolymer latex having a polymer solids content of from 30% to 70%;
1 to 3% of a lower-alkylene glycol;
18 to 23% microsphere filler;
to 1% mica flakes;
1 to 9% colorant; and
1 to 3% of a shear viscosity reducing rheological modifier.

Suitably, the composition is a touch-up paint/filler composition.

In a further aspect this invention resides broadly in a method of repairing a re-entrant defect in a surface including the steps of:
providing a paint composition including 62 to 89 weight % water based urethane copolymer latex having a polymer solids content of from 30% to 70% by weight, 1 to 3 weight % of a lower-alkylene glycol, 8 to 23 weight % microsphere filler, 1 to 9 weight % colorant; and 1 to 3 weight % of a shear viscosity reducing rheological modifier;
substantially filling said re-entrant defect with said composition; and
smoothing the composition to substantially flush with the surface with a flexible edged member.

In the present case, a re-entrant defect may be a scratch, chip, divot, separated conchoidal fracture or other break through the surface of an object. The surface of the object may be gel coated or painted FRP, polymer enamels over steel or other metal, FRP or wood, or porcelain enamelled steel. In the case of a wide and/or deep repair, the substantial filling of the re-entrant defect may comprise two or more stages, wherein a first stage fills the defect to at least 80% to less than 100% of its depth, and a second or more stages finishes substantially filling the defect. For example, a three stage process to fill a deep and wide defect may comprise filling to 80% and 96% on the way to filling the defect by the third stage.

As a single pack product, paint compositions in accordance with the present invention may be prepackaged in a dispenser. The dispenser may comprise a single use or multiple use squeeze package having a nozzle dispensing the paint. The squeeze package may take a form reminiscent of an artist's metal crimp or heat seal crimp poly paint tube. Preferably, the squeeze package is integrally formed with a nozzle or has a nozzle connected to a neck such as by a thread. The nozzle may be closed by a cap for preserving the contents for reuse.

The dispenser or its packaging may include a flexible, edged smoothing member. For example there may be provided a substantially flat polymer body having a precision-cut or formed straight edge which may be used to both smooth and remove the excess of the paint substantially filling the defect. By this means the substantially flat body may be flexed to conform to the contour of the surface being filled, and substantially reproducing that contour in the repair.

In a further aspect this invention resides broadly in a paint dispenser including:
a substantially cylindrical thermoplastic body;
an end portion closing one end of said polymer body and including a dispensing nozzle and a closure therefor;
a heat sealed crimp portion having a straight terminal edge and closing the end of the body opposite the end portion and forming a flexible, spatulate smoothing tool.

The body may comprise a flexible polyolefin that is capable of forming a suitable stiffness in the crimp for use as a tool, such as HDPE. The end portion may be integrally formed with the cylindrical body portion. The dispensing nozzle may be integrally formed with the end portion. The nozzle closure portion may comprise a sealed end of the integral nozzle and/or a press-on or screw cap adapted to engage the nozzle by complementing means such as a screw thread.

To use the dispenser, the repair stages may include cutting the nozzle end and/or removing the screw cap to expose the product in the nozzle. Squeezing the repair product and/or filler through the nozzle into the damaged area until the user sees that the damage is appropriately filled. The tube may then be immediately turned 180 degrees in the same hand. The tube's flexible, spatulate smoothing tool edge may be used to wipe the repair product and/or filler level with the adjoining surface leaving excess repair product and/or filler smears on the adjoining area. The user's free hand may use a paper tissue to wipe off any repair product and/or filler smears on the adjoining area. Thereafter the user may wipe the smoothing tool edge with the free hands tissue until clean.

The repair is complete in seconds, it is exactly level with no excess product on the adjoining area, also has no brush bristle marks in the dried repair. Additionally because the application, levelling and trimming is completed with one hand the user's free hand can remove any excess quickly before the repair product and/or filler can dry.

### EXAMPLE

So that the invention may be readily understood and put into practical effect, reference is made to the following non-limiting example.

A formulation was prepared with the following constituents:
67.12% Sancure 825 polyurethane copolymer coating dispersion (Lubrizol, 34% solids);
2.06% 1,3 propanediol
22.28% microsphere filler (3M, K25)
4.4% white pigment (Degussa Colortrend)
1.22% rheological modifier (Dow Chemical, Acrysol SCT275)

The components were added progressively with mixing into a low shear mixer.

### BRIEF DESCRIPTION OF THE DRAWINGS

The invention will be described with reference to the following non-limiting embodiment of the invention as illustrated in the drawings and wherein:

FIG. 1 is an elevation of paint dispensing apparatus in accordance with the present invention; and

FIG. 2 is a perspective view of the apparatus of FIG. 1.

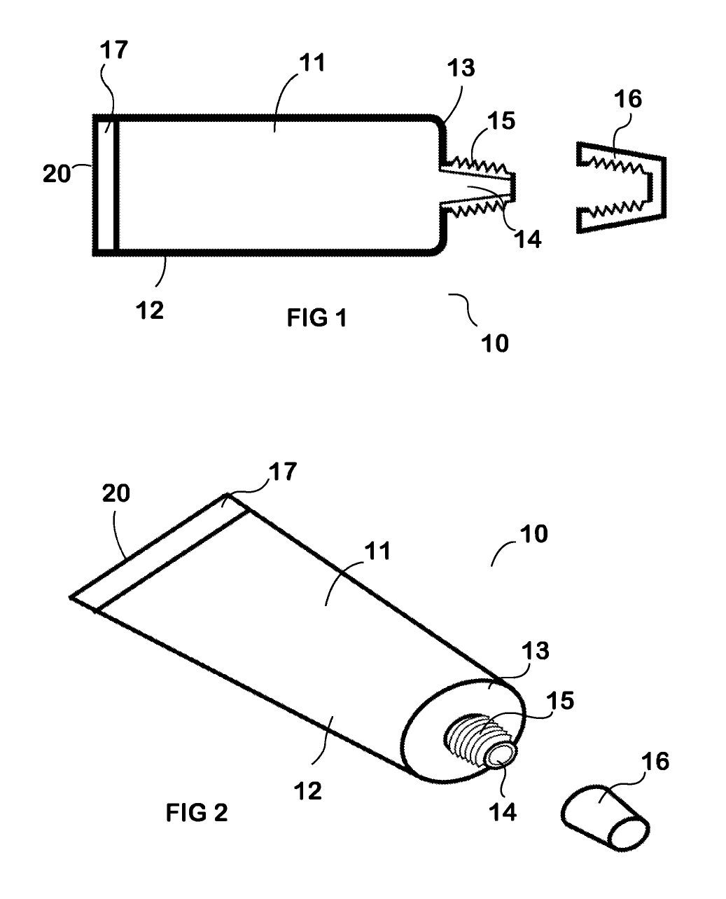

In the figures there is provided a paint dispenser 10 including an HDPE blow moulded container 11 having a substantially cylindrical body 12 closed at one end by an end portion 13. The end portion 13 has integrally formed therewith a dispensing nozzle 14 having a tapered outer thread 15. In this embodiment, the nozzle 14 is made integrally plugged, to be rendered operable by cutting off the plugged end (not shown). A plastic screw threaded cap 16 selectively closes the cut nozzle 14. The cap 16 could just as readily secure an open and unplugged nozzle 14 from manufacture.

The substantially cylindrical body 12 is closed at the end remote from the end portion 13 by means of a heat sealed crimp portion 17 having a straight terminal edge 20. The choice of HDPE and the generous width of the crimp portion 17 forms a flexible, spatulate smoothing tool. The terminal edge 20 is straight, smooth and sheer.

In the case of containers 11 having a nozzle 14 that is unplugged, the crimp portion 20 may be formed before the container 11 is filled through the nozzle 14. In the present embodiment the container 11 is filled through the open end (not shown) of the substantially cylindrical body 12. That is, the end not closed off by the end portion 13. After filling the substantially cylindrical body 12 is then pinched off toward the open end to displace contents from the region of the crimp portion 17. The crimp portion 17 is then heat sealed and sheared to form the edge 20.

Compositions, methods and apparatus in accordance with the foregoing embodiments have the following advantages.

The composition is designed to be applied by everyday consumers, and is not restricted to trade professionals. It is to be applied by plastic applicator that pushes the composition directly into the damage cavity and cleaning away the surrounding excess on a tissue or paper towel. The compositions finish is then confined exactly within the cavity, it is also level, coloured and without brush stroke marks or the like.

The composition also contains additives to produce a paint finish yet fill the cavity to 80 percent of its depth with one application. A second coating will fill to over 96 percent. Visually this height is near level for a visual blend. The composition's 80 percent fill eliminates the need for estimating the amount of filler to be applied and polished. The composition is applied by a plastic trowel so the repair is easy to apply for untrained people.

The embodied composition's glass microspere filler creates a hard surface that is a scratch resistant glass coating.

The composition rarely needs gentle rubbing to remove smears using a polish similar to those used on car paints.

Due to the combination of the spheres, and the choice of rheology modifiers increasing the compositions viscosity the composition, no mixing is required by the user.

This product is a single pack and does not need to be mixed by a user, unlike other fibreglass repair products in the market.

The composition also provides environmental benefits over prior art touch-up paints. Since the present compositions contain hollow air filled glass balls they contain a substantially lower volume of volatile organic compounds (VOC's) than existing touch-up paints which, as mentioned, are often based around particularly volatile solvents such as acetone. The present composition is therefore safer for the user and others nearby as there is a greatly reduced risk of inhaling increased VOC vapours. This allows the present compositions to be used in areas such as a confined garage where the fumes from other paints would quickly become overwhelming and potentially cause health issues for the repairer and other persons nearby. The reduced VOC content is also of benefit in terms of their disposal as the compounds should be allowed to dry and the remaining dry film is then easily wrapped and disposed. The present compositions therefore present a much lower risk to humans, aquatic and plant life.

With reference to the applicator apparatus embodied above, the procedure for use is very easy and intuitive for the applicator yet it achieves a high standard of repair to damaged areas of surface coatings. The speed of cleaning excess onto the tissue achieved in the present example is crucial to removing the repair product smears completely. The straight edge of the tool portion accurately trims level the filler height and leaves no brush bristle lines.

The finished result requires no hand polishing which also results in significant saving of time and requires limited hand skills. The composition requires no rubbing nor leaves burnish marks.

It is a further advantage of the present system that the apparatus stores the composition in a soft plastic tube whereas the prior art composition is stored stores in steel cans or glass. The dispenser is lightweight, easy to grip with a secure seal for product longevity. The HDPE plastic tube can be dropped and stored safely for ongoing usage because it is difficult to break and will not rust.

It will of course be realised that while the above has been given by way of illustrative example of this invention, all such and other modifications and variations thereto as would be apparent to persons skilled in the art are deemed to fall within the broad scope and ambit of this invention as is set forth in the claims appended hereto.

1. A paint composition including, by weight:
62 to 89 weight % water based urethane copolymer latex having a polymer solids content of from 30% to 70% by weight;
1 to 3 weight % of a lower-alkylene glycol;
8 to 23 weight % microsphere filler;
1 to 9 weight % colorant; and
1 to 3 weight % of a shear viscosity reducing rheological modifier.

2. A paint composition according to claim 1, wherein the urethane copolymer latex comprises an acrylic modified cross-linked polyurethane.

3. A paint composition according to claim 1, wherein the lower polyalkylene glycol is 1,3 propanediol.

4. A paint composition according to claim 1, wherein the microsphere filler is selected from silica fillers.

5. A paint composition according to claim 4, wherein the silica filler is selected from glass microballoons having diameters ranging from about 5 to 300 micrometers.

6. A paint composition according to claim 5, wherein the glass microballoons have diameters ranging from more than 5 micro metres to less than 120 micro metres.

7. A paint composition according to claim 1, wherein the colorant comprises a solid colour pigment selected from carbon black, titanium dioxide, other metal oxides, magnesium aluminium silicates, mica particles of varying sizes, and synthetic mineral or organic pigments.

8. A paint composition according to claim 1, wherein the rheology modifier comprise a compound or composition selected to induce shear thinning and/or thixotropy in the composition.

9. A paint composition according to claim 8, wherein the rheological modifier is selected from the group consisting of urethane, hydrophobically modified urethane or alkali soluble rheological modifiers.

10. A paint composition according to claim 9, wherein the rheological modifier is selected from non-ionic urethane rheology modifiers providing low-shear viscosity with shear thinning rheology and thickening efficiency.

11. A paint composition according to claim 10, wherein the rheology modifier comprises between about 0.5% and 1.5% by weight of the composition.

12. A paint composition according to claim 1, and including one or more of surface active additives, co-solvents, and additives to promote drying, film forming and/or adhesion.

13. A paint composition according to claim 5, when formulated by a low shear mixer.

14. A paint composition according to claim 1 and comprising, by weight;
67 to 70% water based urethane copolymer latex having a polymer solids content of from 30% to 70%;
1 to 3% of a lower-alkylene glycol;
18 to 23% microsphere filler;
1 to 9% colorant; and
1 to 3% of a shear viscosity reducing rheological modifier.

15. A paint composition according to claim 1 and comprising, by weight:
67 to 70% water based urethane copolymer latex having a polymer solids content of from 30% to 70%;
1 to 3% of a lower-alkylene glycol;
18 to 23% microsphere filler;
0.1 to 1% mica flakes;
1 to 9% colorant; and
1 to 3% of a shear viscosity reducing rheological modifier.

16. A paint composition comprising, by weight:
67.12% Sancure 825 polyurethane copolymer coating dispersion (Lubrizol, 34% solids);
2.06% 1,3 propanediol
22.28% microsphere filler (3M, K25)
4.4% white pigment (Degussa Colortrend)
1.22% rheological modifier (Dow Chemical, Acrysol SCT275)

17. A method of repairing a re-entrant defect in a surface including the steps of:
providing a paint composition according to claim 1;
substantially filling said re-entrant defect with said composition;
and smoothing the composition to substantially flush with the surface with a flexible edged member.

18. A method of repairing a re-entrant defect in a surface according to claim 17, wherein the defect is selected from a scratch, chip, divot, separated conchoidal fracture or other break through the surface of an object having a surface defined by gel coated or painted FRP, polymer enamels over steel or other metal, FRP or wood, or porcelain enamelled steel.

19. A method of repairing a re-entrant defect in a surface according to claim 17, wherein the filling of the re-entrant defect comprise two or more stages.

20. A method of repairing a re-entrant defect in a surface according to claim 19, wherein a first stage fills the defect to at least 80% to less than 100% of its depth, and a second or more stages finishes substantially filling the defect.

21. A method of repairing a re-entrant defect in a surface according to claim 20, wherein a three stage process comprises filling to 80% and 96% before filling the defect by the third stage.

22. A paint composition according to claim 1, when packaged in a dispenser comprising a single use or multiple use squeeze package having a nozzle dispensing the paint.

23. A paint composition according to claim 22, wherein the dispenser includes a flexible, edged smoothing member.

24. A paint dispenser including:
a substantially cylindrical thermoplastic body;
an end portion closing one end of said polymer body and including a dispensing nozzle and a closure therefor; and
a heat sealed crimp portion having a straight terminal edge and closing the end of the body opposite the end portion and forming a flexible, spatulate smoothing tool.

25. A paint dispenser according to claim 24, wherein the body comprises a flexible HDPE that is capable of forming a suitable stiffness in the crimp for use as a tool.

26. A paint dispenser according to claim 24, wherein the end portion is integrally formed with the cylindrical body portion and the dispensing nozzle.

27. A paint dispenser according to claim 24, wherein the nozzle closure portion is selected from a sealed end of the integral nozzle and/or a press-on or screw cap adapted to engage the nozzle by complementing means.

28. A method of repairing a re-entrant defect in a surface including the steps of:
providing a paint dispenser according to claim 24 with a paint composition; substantially filling said re-entrant defect with said composition by dispensing through said nozzle; and
smoothing the composition to substantially flush with the surface with said flexible, spatulate smoothing tool.
